(19) United States
(12) Patent Application Publication
(10) Pub. No.: US 2024/0306848 A1
(43) Pub. Date: Sep. 19, 2024

(54) SLOPING GRILL GRATE AND DRY COOKING APPLIANCE WITH SLOPING GRILL GRATE

(71) Applicant: Jiulai ZHANG, Reutte (AT)

(72) Inventor: Jiulai ZHANG, Reutte (AT)

(21) Appl. No.: 18/272,363

(22) PCT Filed: Jan. 13, 2022
(86) PCT No.: PCT/EP2022/050598

§ 371 Date: Jul. 14, 2023

(30) Foreign Application Priority Data
Jan. 15, 2021 (DE) 10 2021 200 341.9

(51) Int. Cl. A47J 37/06

(52) U.S. Cl. CPC A47J 37/0694

(57) ABSTRACT

A sloping grillage having improved fat drainage function, for use on a grill or in a dry cooking appliance such as an oven, has a number of food support elements spaced apart from one another. At least 70% the food support elements are each composed of at least two carrier rods without a fat gutter. At least one of the carrier rods is at a distance of less than 1 mm from at least one of the respective other carrier rods, and can preferably be in contact with at least one of the respective other carrier rods. When the sloping grillage is used during grilling, at least two carrier rods of a food support element run at angles of inclination between 1° and 30° to the horizontal from a first of their longitudinal ends to a second of their longitudinal ends.

### TECHNICAL FIELD OF THE INVENTION

The invention relates to a sloping grillage with improved fat drainage function and a dry cooking appliance, such as an oven or grill, with such a sloping grillage.

### TECHNICAL BACKGROUND

Grilling as a form of food preparation is a dry cooking technique based on direct or indirect heat radiation. For this purpose, food is placed over or under a heat source or between two heat sources for a certain cooking time to cause non-enzymatic browning reactions and/or roasting reactions mainly on the surface of the food by strong heating. Fired or glowing carbon-based energy sources such as wood, wood pellets, charcoal, coal briquettes or peat, ignited gas, gas-heated stones or conductive heating elements heated by electric current are used to realize a heat source. Holding devices are necessary for placing the food (or grill food): In addition to grill plates and skewers such as rotisserie skewers, shish kebab skewers or brochettes on which the grill food is placed, grillages are often used on which the grill food is placed.

Especially in charcoal-fired grills, harmful substances from the embers and possibly from fat dripping into the embers can pass into the grill food. The resulting polycyclic aromatic hydrocarbons such as benzopyrene are considered carcinogenic. In addition, fire formation makes grilling more difficult. dry cooking devices heated with gas or electricity basically have similar problems.

There are different solutions for grillages in the prior art, for example providing lateral or indirect heaters, as well as supplementing grooves/ridges below the grate bars. Relevant documents in this regard are EP 1 631 178 A1, WO 2004/107942 A1, U.S. Pat. Nos. 3,369,481 A, 3,664,256 A, 3,719,507 A, DE 391 98 18 A1, DE 298 10 644 U1, DE 296 08 205 U1, DE 200 12 058 U1, DE 103 26 271 A1, DE 199 03 448 A1, DE 20 2005 006 982 U1 and DE 362 01 03 A1.

However, lateral or indirect heat sources make handling very difficult. In the case of indirect heating, a lid is always required and the cooking time is longer. Furthermore, the user is limited in the choice of cooking technology.

Replacing the round bars with V-profiles with a slight inclination, as described for example in DE 792 30 24 U1, DE 24 27 678 A1 or DE 10 2016 211 871 A1, does not achieve the desired effect. The liquid from the grilled food, which lies between the profiles, does not flow into the grooves but along the outer surface to the underside of the profiles and drips from there into the embers. Therefore, a second groove under each profile, as described in wo 2005/112719 A1, is required. However, the relatively complicated design limits broad application.

DE 20 2009 014 563 U1 and KR 20-0461125 Y1 each disclose a grillage with grill bars running obliquely to the horizontal and having integral grease run-off channels. DE 100 33 294 A1 discloses flat grillages with support elements which have curved grease run-off rails on their underside.

Grillages with such grooves or grease run-off rails have the particular disadvantage that the heat radiation directed towards the grilled food is strongly reduced by the grooves and that the grooved or run-off elements are difficult to clean after grilling.

It has been found to be advantageous as described in DE 299 03 212 U1 and DE 100 33 294 A1 that the fat can drain along the underside of the grate when the grate has a slope. This is based on the principle of wetting force between the fat and the grate. DE 299 03 212 U1 discloses a grill with an inclined grill body, whereby solutions with joints are also claimed. These solutions are complicated and entail high costs in production. The publication DE 100 33 294 A1 describes a grate with a casing for each bar of the grate. This construction is also costly. Moreover, smoke-free grilling is not guaranteed with this design if the thickness of the casing sheet is not sufficiently large to ensure sufficient wetting force.

DE 240 22 54 A1 discloses a drip-free grillage. In addition to parallel longitudinal bars, there are also transverse bars, so that a net-like grate is formed. However, such grillages are more complicated and expensive to produce and have an increased weight, which makes it difficult to apply the grate onto a grill body.

DE 197 169 72 A1 discloses a grill that has a fat collection inclination and a fat transport inclination.

The publication DE 10 2010 039 695 A1 discloses sloping grillages that utilize adhesion forces to enable smoke-free grilling. This technology offers adaptation solutions for an sloping grillage for conventional grills such as kettle grills, round grills, column grills, funnel grills, grill carts, swing grills, fireplaces, garden grill fireplaces, etc. For retrofitting existing grills, however, a corresponding grillage must be constructed for each model.

DE 10 2011 089 663 B4 discloses a universally applicable grill attachment made of round bars and whose grill surface is inclined against the horizontal. The grill attachment fits any type of grill and allows for low-smoke grilling due to the inclination of the grill surface.

The principle of transporting excess fat into a fat pan through the interaction of gravity and adhesion forces between fat and grate bars, as disclosed in DE 299 03 212 U1, DE 100 33 294 A1, DE 240 22 54 A1, DE 197 169 72 A1, DE10 2010 039 695 A1 and DE 10 2011 089 663 B4, however, has physical limits. When grilling very fatty grilled food or grilled food with a lot of marinade or when grilling under very strong heat, it can happen that the inclined grate bars can no longer transport the large amounts of oil and fat. A grease fire is no longer controllable. Furthermore, even under favorable grilling conditions, the smoke-reducing effect of the grillage construction deteriorates with increasing grilling duration. In addition, not only fat but also meat juice comes out of meat as grilled food, especially if the grilled food does not lie on the grillage for long. This juice dries due to the heat radiation on the underside of the grate bars and gradually forms deposits that can in turn be potential drip points for fat.

### SUMMARY OF THE INVENTION

One of the tasks of the invention is therefore to find an sloping grillage for dry cooking devices, such as grills or ovens with grill function, whose fat transport properties are improved and do not diminish even during prolonged grilling activity or under strong heat exposure from the heat source of the dry cooking device.

These and other tasks are solved by an sloping grillage with the features of claim 1 and by a dry cooking device with the features of claim 14.

According to a first aspect of the invention, an sloping grillage comprises a number of spaced-apart food support elements. At least 70% of the food support elements are each composed of at least two support bars. These support bars do not have a fat groove. At least one of the support bars is spaced less than 1 mm from at least one of the other support bars and can preferably be in contact with at least one of the other support bars. In the grilling operation of the sloping grillage, at least two support bars of a food support element run at inclination angles between 1° and 30° relative to the horizontal.

The support bars can be straight, curved or spiral. The curved support bars run 2-dimensionally in one plane and the spiral support bars run 3-dimensionally. A food support element can have either only one variant or several variants. That is, the support bars can all be straight, all curved or all spiral in some embodiments. In other embodiments, a food support element can have a straight-running, round cross-section support bar, i.e. a round bar, and several spiral support bars that run helically around the round bar. If the distances between the support bars are small enough, all variants can achieve advantageous technical effects according to the invention.

The support bars in a food support element can be of equal length. In some embodiments, different lengths can be advantageous, for example, if a food support element consists of two trapezoidal strip profiles made of cast iron and a round bar, the round bar should be slightly shorter than the trapezoidal strip profiles. This makes it easier to achieve the small distances between the support bars that have proven to be favorable.

The support bars in a food support element can be parallel to each other in some embodiments. This ensures constant small distances between the support bars over the entire length of the food support element. In other embodiments, a food support element can have a straight round bar and e.g. two spiral round bars.

In principle, all food support elements of an sloping grillage can consist of two or more support bars. To simplify the construction, in some embodiments two laterally located and possibly additional food support elements can each be made from a single support bar. If less than 70% of the food support elements of an sloping grillage consist of two or more support bars, i.e. if more than 30% of the food support elements are each made from a single bar, the desired smoke-reducing effect is not as pronounced.

According to the invention, the support bars of the food support elements do not have a fat groove. A fat groove is a profile with at least one upwardly directed opening, whose ratio between opening width b and profile width B is normally greater than approximately 50%. At an inclination, a liquid can flow in the fat groove from the higher end to the lower end because the two upper edges of the opening prevent the liquid from overflowing. Grooves with an upwardly directed opening that is suitable for fat transport due to the limitation of the upper edges of the opening can be considered as fat grooves. Fat grooves generally shield heat radiation and make cleaning more difficult. To be distinguished from fat grooves are grooves that play a subordinate role in the transport of fat due to the limitation of the upper edges of the opening because either the fat immediately overflows due to too small groove dimensions or the grooves do not have an upwardly directed opening. The ratio b/B for grooves is significantly smaller than 50%, and can be zero in some embodiments because none of the openings formed by the grooves are directed upwards.

The distance between the support bars of a food support element should be less than 1 mm, preferably less than 0.5 mm. If the distance is equal to zero, i.e. the support bars are adjacent to each other with their outer surface, the production can be simple, the desired capillary effect can be ensured and the grilled food can receive maximum heat conduction from the support bars. In this case, the fat can also easily flow through the small passage points between two support bars due to the roughness of the support bar surfaces that is usually present. That is, the two adjacent support bars do not form a fluid-tight barrier. With a sufficiently small distance between the support bars, a capillary effect is created between adjacent support bars, which ensures that capillary menisci are formed in which large amounts of liquid, which are much larger than the amount that can be transported by two individual bars, can be transported without the liquid dripping down from the support elements. At distances of more than 1 mm between the support bars, simultaneous wetting by liquid is more difficult, so that gravity dominates over the capillary effect. The fat transport capability would then be no different from that of an sloping grillage according to the prior art.

With an inclination of the support bars of a food support element in the grilling operation of the sloping grillage relative to the horizontal, liquid such as fat and meat juice that occurs during grilling can safely flow along the support bars of the support element through the interaction between gravity and adhesion forces on the support bars without dripping beforehand. The greater the inclination, the better the smoke-reducing effect. But a large inclination means more heat unevenness for the grilled food. The inclination of the support bars in grilling operation should be 1°-30° relative to the horizontal, preferably 3°-15°, even more preferably 5°-10°. With an sloping grillage according to the invention, a relatively lower inclination is sufficient for a smoke-reducing effect compared to an sloping grillage according to the prior art with individual support bars.

The straight support bars have a constant inclination angle in grilling operation. With 2-dimensional curved support bars, there is no constant inclination angle. The location-dependent inclination along the longitudinal extent varies around an average inclination. Therefore, the support bars of a food support element in the grilling operation of the sloping grillage run at varying inclination angles between 1° and 30° relative to the horizontal along the longitudinal extent. With spiral support bars, the inclination angle also varies along the longitudinal extent. With food support elements consisting of three or more spiral support bars, a straight center channel is formed whose longitudinal axis is equal to the longitudinal axis of the spiral bars. With an inclination of the center channel by 1° to 30°, the fat flows due to the interaction of adhesion and gravity along the support bars to a fat collection container. Here, the inclination of the longitudinal axis of the spiral bars, instead of the inclinations of the individual spiral bars, is decisive for the effectiveness of fat transport. With food support elements consisting of a straight round bar and a plurality of circumferential spiral bars, the capillary effect of the center channel is further enhanced by the round bar. With an inclination of the round bar by 1° to 30°, the fat flows along the support bars to fat collection containers. Here again, the inclination of the longitudinal axis of the spiral bars, which is equal to the inclination of the round bar, instead of the inclinations of the individual spiral bars, is decisive for fat transport. Therefore, the inclination of the longitudinal axis of the spiral support bars is defined as the inclination of the spiral support bars. That is, in grilling operation of an sloping grillage, the spiral support bars of a food support element should run at an inclination angle of 1°-30°.

That at least one of the support bars is spaced less than 1 mm from at least one of the other support bars means that, for example, with three support bars in a food support element, only one of the support bars can be spaced less than 1 mm from only one support bar. The third support bar can be spaced more than 1 mm from the other two support bars. That in the grilling operation of the sloping grillage at least two support bars of a food support element run at inclination angles between 1° and 30° relative to the horizontal means that, for example, with three support bars in a food support element, only two support bars can be inclined against the horizontal by 1°-30°. The third support bar can run, for example, in a horizontal direction, i.e. without inclination. The above-mentioned two cases apply when, for example, in a food support element a horizontally running support bar is located above two inclined two support bars inclined by 1°-30° relative to the horizontal whose distance from each other is less than 1 mm. The fat from the grilled food can then drip from the upper support bar onto the lower two inclined support bars that transport the fat to the fat collection container. The deposits that form on the upper support bar do not interfere. All grilled food is heated evenly because there is no longer any difference in height on the food support surface.

Sloping grillages can have arrangements of heat-resistant, in particular metallic, food support elements whose surface coverage in the grate plane is normally less than the spaces between the individual food support elements. Smaller spaces can be advantageous when small pieces of grilled food are grilled. For this purpose, a net-like underlay can additionally be used on the sloping grillage. Such underlays do not affect the technical effect of the sloping grillage according to the invention.

Sloping grillages can be rectangular, round, oval, trapezoidal, octagonal, hexadecagonal, triangular, pentagonal, semicircular or of any other shape. The sloping grillage can have a grillage frame in some embodiments in which the food support elements are inserted. Grillage frames can also be integrated into the grill body. That is, the food support elements are inserted into designated openings in the grill body.

According to a second aspect of the invention, a dry cooking device, in particular an oven or a kettle grill, round grill, column grill, funnel grill, swing grill, garden grill, grill cart, table grill, camping grill, grill station or grill fireplace comprises a cooking chamber and at least one sloping grillage arranged in the cooking chamber according to the first aspect of the invention. Heat sources for the dry cooking device can be charcoal, charcoal briquettes, wood, wood pellets, gas or electricity.

One of the essential ideas of the invention is to equip a sloping grillage with several support elements for grilled food, which in turn each consist of at least two support bars. In this case, the at least two support bars are arranged in close proximity or directly next to each other, while the support elements themselves are further apart, e.g. between 5 mm and 20 mm. With a sufficiently small distance between the support bars, a capillary effect is created between adjacent support bars, which ensures that capillary menisci are formed in which large amounts of liquid, in particular fat and meat juice from the grilled food, can be collected without the liquid dripping down from the support elements.

A particular advantage of the inventive solution results from the fact that fat runnels or fat grooves on the support elements are not necessary because fat can mainly be transported along the capillary menisci. By dispensing with complicated and space-consuming fat runnels or fat grooves, less heat is shielded from the grilled food with the sloping grillage of the invention. In addition, cleaning of the sloping grillage of the invention is considerably simplified because the individual elements of the grillage remain very easily accessible. Compared to the prior art where fat only flows along the underside of the bars of an sloping grillage, the invention is advantageous. By transporting fat mainly through capillary menisci more fat can be transported and the effect maintains through the whole grilling duration, because deposits are no longer mandatory fat drip points. Furthermore, the inclination of the sloping grillage can be kept low, which is why grilled food can be grilled more evenly.

An sloping grillage according to the first aspect of the invention can be used both as a component of a new grill and as a retrofit system for existing grills. For example, support elements can be fixed at one end of the sloping grillage that generate an inclination of the sloping grillage either on a flat surface of the grill body or as an attachment to an already existing grillage of a conventional grill system. Alternatively or additionally, the grillage frame can have different thicknesses at different ends, so that when the grillage frame is placed on a flat surface, the food support elements are inclined relative to the horizontal.

Alternatively, the grill can have differently high supports for the two ends of the grillage. The sloping grillage according to the invention can be placed directly on a base without additional support elements so that the desired inclination of the sloping grillage is achieved. An additional fat collection container can be attached as a further element to the sloping grillage as an extension at its lower end to collect dripping fat. As part of a new grill, the food support elements can be inserted into designated openings in the grill body. The openings on one side are higher than on the other side, so that the inclination of the food support surface of the sloping grillage can be adjusted.

A roof-shaped grill attachment with two fat collection containers is well suited as a universal grill attachment both as part of a new grill and for retrofitting. By halving the height difference, the temperature distribution is more even. With two fat containers, placing a grill attachment on a grillage is easy.

The number of inclined food support surfaces can be varied in an sloping grillage according to the first aspect of the invention by suitable selection and arrangement of the food support elements, depending on the intended use of the sloping grillage. The use of multi-part sloping grillages offers advantages with regard to cleaning in a dishwasher due to smaller dimensions or facilitating the addition of charcoal during grilling.

Advantageous embodiments and further developments result from the further subclaims and from the description with reference to the figures.

According to some further embodiments of the sloping grillage, at least one of the support bars of the food support elements can each have a round bar and at least one of the support bars of the food support elements can have a non-round profile. Round bars are very easy and inexpensive to produce, due to their external shape also very easy to clean, and less susceptible to adhesion of the grilled food. Cast iron and sheet metal offer greater design freedom. The combination of round bar/round bars with non-round profile, for example made of cast iron or sheet metal, enables easy cleaning, less sticking of grilled food, the generation of the desired capillary effect and advantageous design freedom. For example, with a combination of two trapezoidal bars and a round bar in a support element, the capillary effect can best be enhanced; or a round bar flanked by two C-shaped strip profiles. In addition, such combinations are easy to clean and have a low weight due to their design.

According to some further embodiments of the sloping grillage, all of the support bars of the food support elements can each have a non-round profile, such as a polygonal strip profile. This polygonal strip profile can be, for example, a rectangular or trapezoidal strip profile. The profiles can be cast iron, rolled wire/drawn wire/extruded wire or sheet metal profiles that are manufactured by sheet metal forming. One example is three rectangular strip profiles next to each other. Another example is three trapezoidal strip profiles next to each other.

According to some further embodiments of the sloping grillage, all of the support bars of the food support elements can each have a round bar. Such sloping grillages with round bars are easy to manufacture, avoid adhesion of grilled food to the support bars and are easy to clean.

According to some further embodiments of the sloping grillage, at least 70% of the food support elements can each be composed of at least three support bars. Although a good capillary effect can already be achieved with two support bars, the capillary effect can be enhanced by forming center channels running between three or more support bars. Such center channels can also be used for transporting liquid such as fat or meat juice. More than three support bars in a food support element make the sloping grillage heavier. Food support elements with 3 or 4 bars can offset this disadvantage.

According to some further embodiments of the sloping grillage, at least one of the support bars of the food support elements can be arranged offset by a depth distance perpendicular to the food support plane spanned by the food support elements. Such arrangements of support bars above each other can favor that fat drips less on deposits and that more fat is transported away. On the one hand, the path of the liquid from the grilled food to the underside of the food support element becomes longer. As a result, the escaping liquid may already have been dried on the way. Therefore, fewer deposits form on the underside of the food support element. On the other hand, with an arrangement of support bars above each other, the fat must pass between two support bars. There, due to the capillary effect, the fat will form capillary menisci and be transported in the direction of the fat collection containers under the influence of gravity instead of continuing to flow vertically downwards to the deposits. In addition, center channels that can transport larger amounts of fat can form in food support elements with three or more bars in an arrangement of support bars above each other. With an arrangement of support bars next to each other, no center channels are formed.

According to some further embodiments of the sloping grillage, at least two support bars in a food support element can be connected in several places in the longitudinal direction. These connections hold the support bars together or stabilize the support bars. Sometimes the connections can form a complete crossbar that connects all food support elements and possibly the grillage frame. This can stabilize the support bars or compensate for brittleness in the material of the support bars. In some variants, several spaced crossbars are useful.

According to some further embodiments of the sloping grillage, at least one of the support bars of the food support elements can have recesses, preferably along the bar extension direction, on at least one side surface closest to one of the other support bars. In some embodiments, the recesses can have a depth between 10 μm and 2 mm. Especially with support elements that have support bars next to each other, the effective surface of the support bars can be increased and thus the capillary effect improved by creating recesses. Such recesses can have grooves, lowered channels or other patterns that break up the smooth surface. Grooves can be realized, for example, by corrugated sheet metal, but also by material processing methods such as wire drawing, rolling, pressing or extrusion. Furthermore, recesses can also be created by coarse grinding, sandblasting or shot peening.

According to some further embodiments of the sloping grillage, at least one of the support bars of the food support elements can have different cross-sectional dimensions than the other support bars. With food support elements that only have round bars or only non-round profiles, different dimensioning of the support bars is sometimes also useful. For example, a food support element with a thick round bar below two thinner round bars can combine good stability through the thick round bar with weight reduction through the two thinner round bars.

According to some further embodiments of the sloping grillage, the food support elements standing at a distance from each other can run parallel to each other along their longitudinal direction. Such constructions are easy to manufacture and guarantee a very good liquid or fat drain.

Alternatively, according to some further embodiments of the sloping grillage, the food support elements standing at a distance from each other can run along their longitudinal extent radially from the circumference of the grillage frame to a center point of the circular grillage frame. With round and kettle grills, a radial arrangement of support elements is useful if the fat is to be collected in the center of the grill.

According to some further embodiments of the sloping grillage, the support bars of the food support elements standing at a distance from each other can be connected to the grillage frame or crossbars in a displaceable manner along their longitudinal extent relative to the grillage frame or crossbars. If the support bars were firmly connected to the frame or crossbars, the support bars could deform under uneven or excessive heat, so that the distances between the support bars in a support element would unintentionally become too large, which would reduce the formation of the capillary effect. If, on the other hand, the support bars are flexibly connected to the grillage frame or crossbar, each support bar in a support element can expand freely without deformation when heated. In addition, cleaning is advantageously facilitated with flexible support bar connection. For example, recesses in round tube, square tube, C-profile or U-profile or other profiles can be processed by machining, water jetting, laser cutting, plasma cutting, punching or deep drawing. For example, two threaded rods, two bolts, two round bars or two profiles, together with the two frame profiles that have a plurality of recesses, can form screwed stable frames. The support bars are inserted into the recesses. After tightening the screw connection firmly, the support bars can still move freely along their longitudinal extent. The gap of the support bars can be variably adjusted by an appropriate adjustment of the screw connection. Instead of screw connections, other connections can also be used. Instead of recesses, openings in bent sheet metal or wire can also be used.

Dry cooking devices, e.g. ovens, grills of any kind, e.g. kettle grill, round grill, column grill, funnel grill, swing grill, garden grill, grill cart, grill station or grill fireplace with an sloping grillage according to the invention are very low in smoke when grilling and this effect does not diminish with continued grilling time.

According to some embodiments of the dry cooking device, the dry cooking device can further have at least one fat collection container. This fat collection container can be arranged, for example, under the lowest point of the sloping grillage relative to the horizontal within the cooking chamber. For a charcoal grill, such a fat collection container can be useful. Instead of a fat collection container with a closed side wall, the fat collection container can be open and lead further to a possibly closed fat collection container. With a gas grill, an open fat collection container is conceivable. The fat first lands on the base for the sloping grillage, which acts as an open fat trap; it then flows off on a fat collecting sheet below the gas burners to another fat collecting container that can be located below the fat collecting sheet.

According to some further embodiments of the dry cooking device, the cooking chamber can have a circular cross-sectional profile, especially when the sloping grillage has food support elements standing at a distance from each other that run radially from the circumference of the grillage frame to a center point of the circular grillage frame along their longitudinal extent. Above the fat collection container, the sloping grillage can have a central grillage part with a flat food support surface that is suitable for indirect grilling. A cooking chamber can also be open on at least one side, such as with a grill without a lid or cover.

According to some embodiments of the dry cooker, the dry cooker may further comprise a heat source whose heat-generating elements are arranged substantially at a constant distance from the food support elements of the sloping grillage in the cooking chamber. This is particularly advantageous when the heat gradient along the entire food support surface of the sloping grillage is to be kept as small as possible so that food can absorb the same amount of heat at any part of the food support surface. For example, in a gas grill, the gas burners can run parallel to the food support elements. This heats the food evenly everywhere. If the gas grill has flame covers, these can also run parallel to the grill surface. In a charcoal grill, the bottom or grate of the charcoal bowl can also run parallel to support elements. This heats the food evenly everywhere.

Because the sloping grillage according to the first aspect of the invention can greatly reduce dripping of fat downwards, such an sloping grillage can also be useful for use in an oven. Advantageously, it is then possible to dispense with the introduction of a water bowl into the cooking chamber of the oven when using the grill function. It may be possible to place a grease container only at the low end of the sloping grillage. In addition, it may be possible to heat the food in the oven not only from above, but to implement a grill function with simultaneous top and bottom heat.

The above embodiments and developments can be combined with each other as desired, if sensible. Further possible embodiments, developments and implementations of the invention also include combinations of features of the invention described previously or below with respect to the exemplary embodiments that are not explicitly mentioned. In particular, the person skilled in the art will also add individual aspects as improvements or additions to the respective basic form of the present invention.

### BRIEF SUMMARY OF THE FIGURES

The present invention is explained in more detail below with reference to the exemplary embodiments shown in the schematic figures. The figures show:

FIG. 1a is a cross-sectional view of two support elements of an sloping grillage according to the prior art;

FIG. 1b is a side view of the sloping grillage of FIG. 1a;

FIG. 1c is a side view of the sloping grillage of FIG. 1a after prolonged use in grill operation;

FIG. 2 is a cross-sectional view of two support elements of an sloping grillage according to an embodiment of the invention;

FIG. 3a is a cross-sectional view of two support elements of an sloping grillage according to another embodiment of the invention;

FIG. 3b is a cross-sectional view of one support element of an sloping grillage according to another embodiment of the invention;

FIG. 3c is a side view of the sloping grillage of FIG. 3b;

FIG. 4a is a cross-sectional view of a variant of a support element of an sloping grillage according to another embodiment of the invention;

FIG. 4b is a cross-sectional view of a variant of a support element of an sloping grillage according to another embodiment of the invention;

FIG. 4c is a cross-sectional view of a variant of a support element of an sloping grillage according to another embodiment of the invention;

FIG. 4d is a cross-sectional view of a variant of a support element of an sloping grillage according to another embodiment of the invention.

FIG. 4e is a cross-sectional view of a variant of a support element of an sloping grillage according to another embodiment of the invention;

FIG. 4f is a cross-sectional view of a variant of a support element of an sloping grillage according to another embodiment of the invention;

FIG. 4g is a side view of the sloping grillage of FIG. 4f;

FIG. 5a is a cross-sectional view of two support elements of an sloping grillage according to another embodiment of the invention;

FIG. 5b is a top view of the sloping grillage of FIG. 5a or 5c;

FIG. 5c is a cross-sectional view of a variant of a support element of an sloping grillage according to another embodiment of the invention;

FIG. 6a is a cross-sectional view of a variant of a support element of an sloping grillage according to another embodiment of the invention;

FIG. 6b is a top view of the sloping grillage of FIG. 6a or 6c;

FIG. 6c is a cross-sectional view of a variant of a support element of an sloping grillage according to another embodiment of the invention;

FIG. 6d is a top view of an sloping grillage with cross bar and without frame according to another embodiment of the invention;

FIG. 7a is a cross-sectional view of a variant of a support element of an sloping grillage according to another embodiment of the invention;

FIG. 7b is a cross-sectional view of a variant of a support element of an sloping grillage according to another embodiment of the invention;

FIG. 8a is a cross-section through the side view of a kettle grill with an inclined funnel-shaped grillage and central fat collection bowl according to another embodiment.

FIG. 8b is a top view of the funnel-shaped sloping grillage of the kettle grill of FIG. 8a;

FIG. 9a is a cross-section through the side view of a kettle grill with a V-shaped sloping grillage and a central fat collection bowl according to another embodiment of the invention;

FIG. 9b is a top view of the V-shaped sloping grillage of the kettle grill of FIG. 9a;

FIG. 9c is a cross-section through the side view of a kettle grill with a V-shaped sloping grillage and two lateral fat collection bowls according to another embodiment of the invention;

FIG. 10a is a cross-section through the side view of a gas grill with an sloping grillage according to another embodiment of the invention;

FIG. 10b is a cross-section through the side view of a charcoal grill with an sloping grillage according to another embodiment of the invention;

FIG. 10c is a cross-section through the side view of a gas grill with two V-shaped sloping grillages according to another embodiment.

FIG. 11 is an exemplary sketch of a fat gutter according to the prior art;

FIG. 12 is a perspective view of a variant of a support element of an sloping grillage according to another embodiment of the invention;

FIG. 13 is a top view of a grillage frame segment for receiving carrier rods of an sloping grillage according to another embodiment of the invention;

FIG. 14 is a top view of an sloping grillage according to another embodiment of the invention; and

FIG. 15 is a top view of an sloping grillage according to another embodiment.

The accompanying figures are intended to provide further understanding of the embodiments of the invention. They illustrate embodiments and serve in conjunction with the description to explain principles and concepts of the invention. Other embodiments and many of the stated advantages result with regard to the drawings. The elements of the drawings are not necessarily shown to scale with each other. Directional terminology such as “top”, “bottom”, “left”, “right”, “above”, “below”, “horizontal”, “vertical”, “front”, “back” and similar indications are used only for explanatory purposes and do not serve to limit the generality to specific embodiments as shown in the figures.

In the figures of the drawing, identical, functionally identical and equally effective elements, features and components—unless otherwise stated—are each provided with the same reference numerals.

### DESCRIPTION OF EMBODIMENTS

Grilling in the sense of the present disclosure encompasses a form of food preparation that refers to a dry cooking technique based on direct or indirect heat radiation, particularly with strong heat development on and in the food, caused by one or more heat sources arranged near the food.

Food in the sense of the present disclosure includes any form of food prepared by grilling, particularly fatty foods such as meat, fish, marinated vegetables or grilled cheese (also referred to as grilled food).

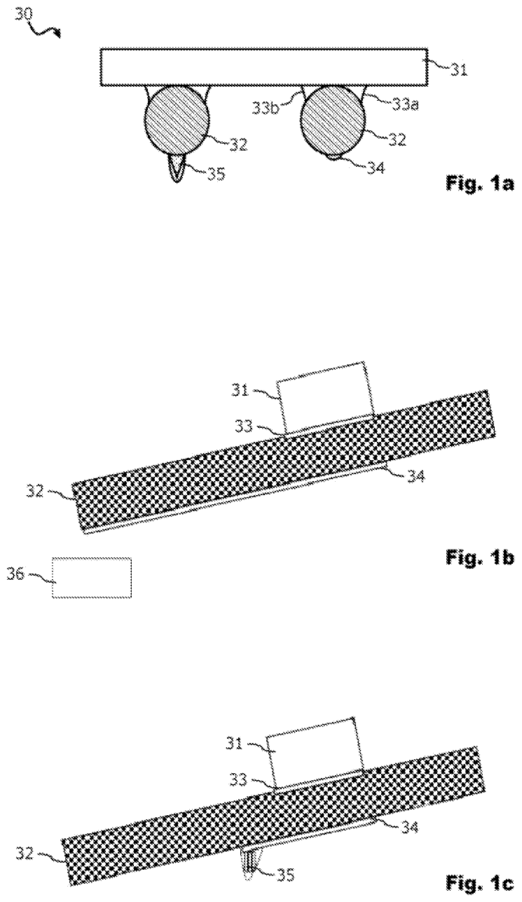

In FIGS. 1a, 1b and 1c, details of a known sloping grillage 30 are shown, which has several support elements 32. The support elements 32 can be, for example, round rods that are arranged substantially parallel to each other and at a certain distance. FIG. 1a shows a cross-sectional view of two such round rods 32 that are inclined relative to the horizontal. Food 31, such as a piece of meat, rests on the two round rods 32.

Fat that can escape from the food 31 initially collects in a fat film 33 due to the capillary forces prevailing between the food 31 and the respective round rod 32, forming left and right menisci 33a and 33b between the round rod 32 and the food 31 (illustrated in FIG. 1a with short concave curve sections). The fat flows under the influence of gravity and adhesion forces along the surface of the round rods 32 to their underside and forms fat films or fat droplets 34. These fat droplets 34 then flow along the inclined round rods 32 in the direction of a fat pan 36 schematically shown in FIG. 1b when the sloping grillage 30 is inclined. FIG. 1b shows the sloping grillage 30 under ideal conditions, under which all fat flows into the fat pan 36 and does not drip down beforehand.

Often not only fat but also meat juice escapes from the food 31, especially when the food 31 has just been placed on the sloping grillage 30. The meat juice dries out due to the stronger heat development on the underside of the round rods 32, so that deposits 35 can gradually occur, one exemplary deposit 35 being shown on the underside of the left round rod 32 in FIG. 1a. Such deposits 35 represent potential dripping points for fat. FIG. 1c shows the sloping grillage 30 under such deteriorated boundary conditions, under which the fat from the food drips off at deposit and cannot or at least not completely reach the fat pan.

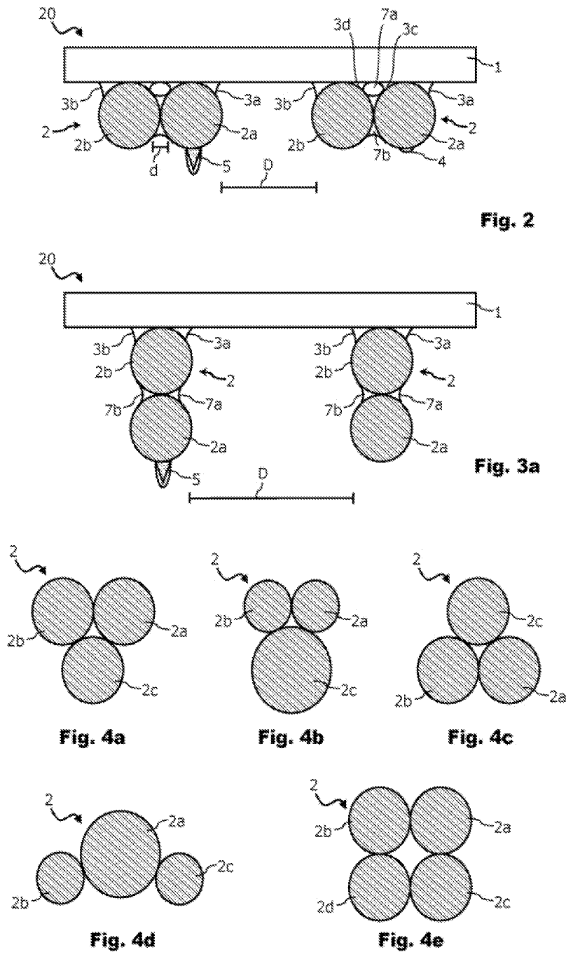

In FIG. 2, a cross-sectional view of two food support elements 2 of an sloping grillage 20 is illustrated, which do not have fat gutters. A fat gutter according to the prior art is shown in FIG. 11. On the two food support elements 2, a piece of food 1—for example a piece of meat, a sausage or a grilled cheese—is schematically shown, which rests on the tops of the food support elements 2. The two food support elements 2 are spaced apart by a relatively large distance D. D can be, for example, 5 mm-20 mm. The diameter of the round rod can be e.g. 2 mm-6 mm. Each of the food support elements 2 can be provided for putting into a grillage frame or cross bars. In FIG. 13, a grillage frame segment with a plurality of recesses for receiving carrier rods is shown. The carrier rods can simply be inserted into the recesses. The carrier rods are not connected to each other. The dimension of the recesses defines the distance between carrier rods 2a and 2b. By e.g. two bolts that are inserted into the two round holes in FIG. 13 and screwed on with nuts, a stable sloping grillage 20 is formed. After tightening the screw connection, the carrier rods 2a and 2b have some play along their longitudinal extension. This can prevent deformation of the carrier rods in case of uneven heat. The bolts can also be considered as food support elements. Therefore, not all of the food support elements need to have at least two carrier rods. Such food support elements cannot transport as much fat as food support elements with more carrier rods, but simplify the construction. Instead of screw connections, other connections can also be used that allow the carrier rods to expand freely in case of uneven heat. For example, the two lateral food support elements can be made from round rods with a shoulder. After inserting the shoulder into the hole, a pin is inserted into a small hole in the shoulder to prevent the shoulder from slipping out of the grate frame segment. In FIG. 14, an sloping grillage 20 without a frame, but only with cross bars 8 is shown. The carrier rods 2a and 2b can be connected to each other by multiple electric spot welding to form a food support element 2. The connections between cross bars 8 and carrier rods 2a and 2b can also be made by spot welding. Spot welds do not adversely affect the flow of fat between the rods. A sloping grillage with a frame can also be built using the same method. Such a sloping grillage 20 can be used, for example, in a gas grill where strong uneven heat does not usually occur.

A number of the food support elements 2 comprise two round carrier rods 2a and 2b, which are substantially the same length and are spaced apart by a distance d, which is less than 1 mm. In the example of FIG. 2, the distance d is even 0 mm, i.e., the two carrier rods 2a and 2b adjoin each other and are in mutual contact with each other. d=0 mm simplifies production, ensures a good capillary effect and is therefore preferred. d=0 mm means that the rods lie against each other. With d=0 mm, the fat can also pass through small spaces between two carrier rods 2a and 2b to form the capillary meniscus 7b, since the surface of the carrier rods 2a and 2b has a certain manufacturing-related roughness.

The carrier rods 2a and 2b of each of the food support elements 2 run parallel to each other. In grill operation of the sloping grillage 20, they run at an inclination angle between 1° and 30° relative to the horizontal, so that liquid or fat droplets that collect at the capillary menisci 7a and 7b run off along the carrier rods 2a and 2b due to a gravity component.

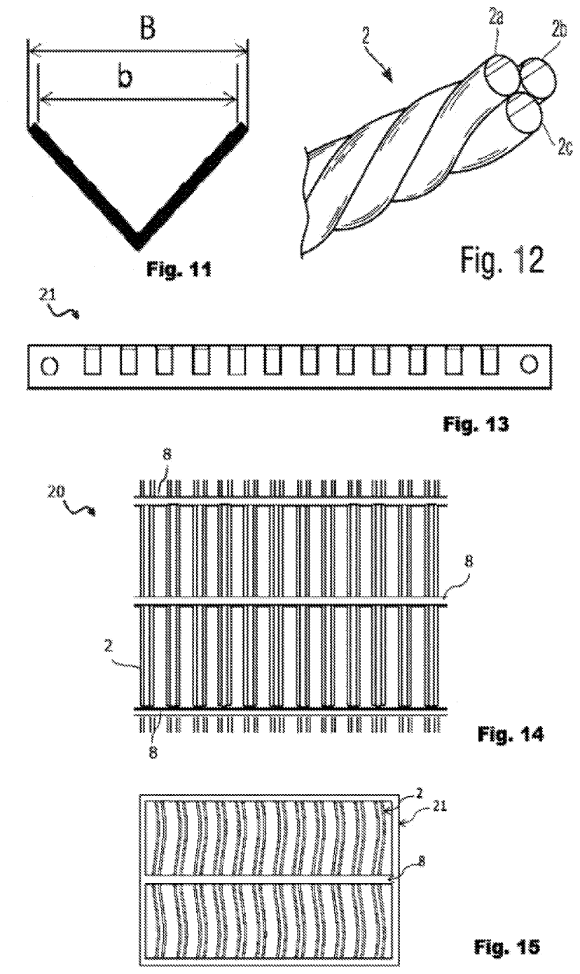

It can also be possible for the carrier rods to run curvilinearly or spirally. An exemplary embodiment of a food support element 2 with three helically winding carrier rods 2a, 2b and 2c is exemplarily illustrated in FIG. 12.

As already explained in connection with FIG. 1a, fat that can escape from the food 1 initially collects in a fat film due to the capillary forces prevailing between the food 1 and the respective carrier rod 2a or 2b, forming left and right menisci 3a and 3b, 3c and 3d between carrier rod 2a or 2b and food 1 (illustrated in FIG. 2 with short concave curve sections). At the same time, however, further fat films also form at the boundaries of both carrier rods 2a and 2b. This increases the effective surface area of the food support elements 2 compared to the round rods 32 shown in FIG. 1a and improves the fat absorption capacity of the food support elements 2. Therefore, the fat transport capacity of the two carrier rods 2a and 2b is much greater than the fat transport capacity of two individual rods that are spaced more than 1 mm apart. The fat then flows under the influence of gravity and adhesion forces along the surface of both carrier rods 2a and 2b to their underside and to the capillary menisci 7a and 7b and forms fat films or fat droplets there. These fat films and any fat droplets then flow off along the inclined carrier rods 2a and 2b when the sloping grillage is inclined.

It is particularly advantageous that deposits 5 cannot be completely avoided, but much less fat will drip off at such deposits 5, since flowing fat can mainly flow off between the carrier rods 2a and 2b via the capillary menisci 7a and 7b. No deposit 5 can form at these boundary points between the two carrier rods 2a and 2b due to the design.

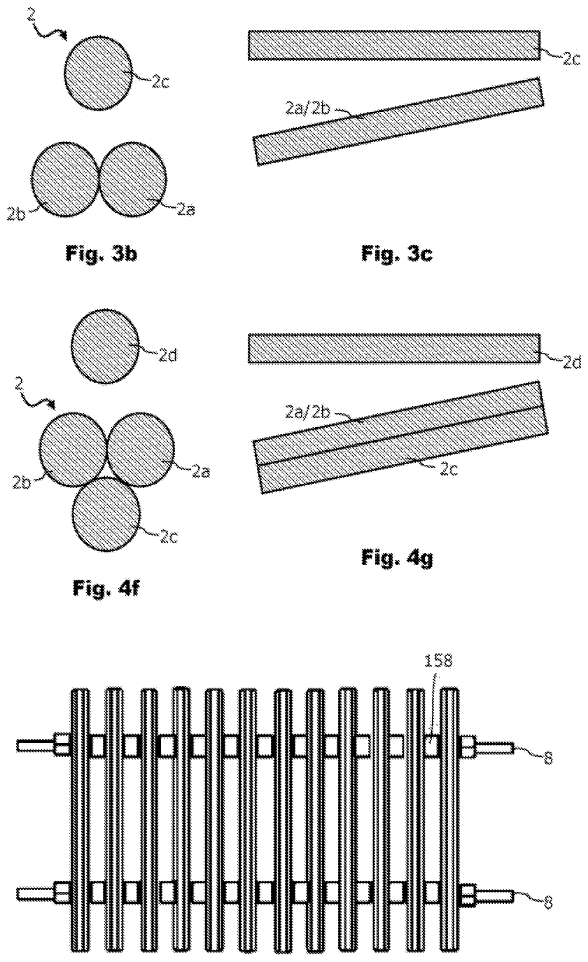

In FIG. 3a, a cross-sectional view of two differently constructed food support elements 2 of a sloping grillage 20 is illustrated. Basically, the food support elements 2 in FIG. 3a also have two round carrier rods 2a and 2b, but they are not arranged next to each other (as in FIG. 2), but on top of each other. As with the construction of FIG. 2, the fat from the food 1 is mainly transported through the capillary menisci 7a and 7b between the two carrier rods 2a and 2b and deposits 5 play only a subordinate role for dripping fat. Fat that runs down from menisci 3a and 3b along carrier rod 2b is more or less completely sucked up by capillary menisci 7a and 7b. In addition, the path from the food 1 to the underside of the lower carrier rod 2a is longer, so that any meat juice usually dries out on the way already, and thus fewer deposits 5 can form. This can effectively prevent fat fire even over a longer grilling period.

FIGS. 3b (cross-section of 3c) and 3c show another example. In a food support element 2 there is a horizontally running carrier rod 2c above two carrier rods 2a and 2b inclined by 1°-30° relative to the horizontal, whose distance d from each other is less than 1 mm, preferably equal to 0 mm. The fat from the grilled food drips from the upper carrier rod 2c onto the lower two inclined carrier rods 2a and 2b, which transport the fat to a fat collection container. The deposits that form on the upper carrier rod 2c do not interfere. All grilled food receives uniform heat because there is no longer any difference in height at different points on the food support surface. The disadvantage is that potentially more heat radiation is shielded by the lower carrier rods 2a and 2b.

In FIGS. 4a to 4e, various variants of food support elements 2 are shown that can have different arrangements, cross-sectional sizes and quantities of round carrier rods 2a, 2b, 2c or 2d. Each of these variants can be suitable for use in an sloping grillage 20. The number of carrier rods can be three, four or more. The carrier rods 2a, 2b, 2c or 2d can be round rods of the same or different diameter. It may be possible, for example, to provide two carrier rods 2a, 2b as round rods with the same diameter and one carrier rod 2c as a round rod with a larger diameter. In FIG. 4b, a thicker carrier rod is arranged below two smaller carrier rods with 50% diameter. The large carrier rod can also be above the two small carrier rods. The carrier rods 2a, 2b, 2c or 2d can each be arranged pairwise with a distance of less than 1 mm from each other, preferably abutting. Pairwise means between 2a-2b, 2a-2c, 2b-2c in FIGS. 4a, 4b and 4c, 2a-2b and 2a-2c in FIG. 4d, 2a-2b, 2a-2c, 2b-2d and 2c-2d in FIG. 4e. The distance 2b-2c in FIG. 4d can be greater than 1 mm. It is possible to provide variants with a first number of carrier rods next to each other and a second number of carrier rods below the first number of carrier rods. In this case, at least one of the carrier rods of the food support elements 2 is arranged vertically offset downwards from the food support surface by a depth distance. This is the case in FIGS. 4a, 4b, 4c and 4e. The variants generally have in common that additional drainage channels for liquid or fat can be created in the gaps between the carrier rods 2a, 2b, 2c or 2d. In the variant FIG. 4d there is no drainage channel. Here it is advantageous if the carrier rod 2a is slightly higher than the carrier rods 2b and 2c. Then the fat has to flow between two carrier rods and can be sucked up by the capillary meniscus between the carrier rods 2a and 2b or between carrier rods 2a and 2c. If all three carrier rods are of equal height, the fat can flow along the outside of carrier rods 2b or 2c. Fat can drip off deposits that may have formed on the underside of carrier rods 2b or 2c.

FIGS. 4f (cross-section of 4g) and 4g show another example. In a food support element 2 there is a horizontally running carrier rod 2d above three carrier rods 2a, 2b and 2c inclined by 1°-30° relative to the horizontal, whose distance d from each other is less than 1 mm, preferably abutting. The fat from grilled food drips from the upper carrier rod 2d onto the lower three inclined carrier rods 2a, 2b and 2c, which transport the fat to a fat collection container. The deposits that form on the upper carrier rod 2d do not interfere. All grilled food is heated evenly due to the flat food support surface, even if more heat radiation is shielded.

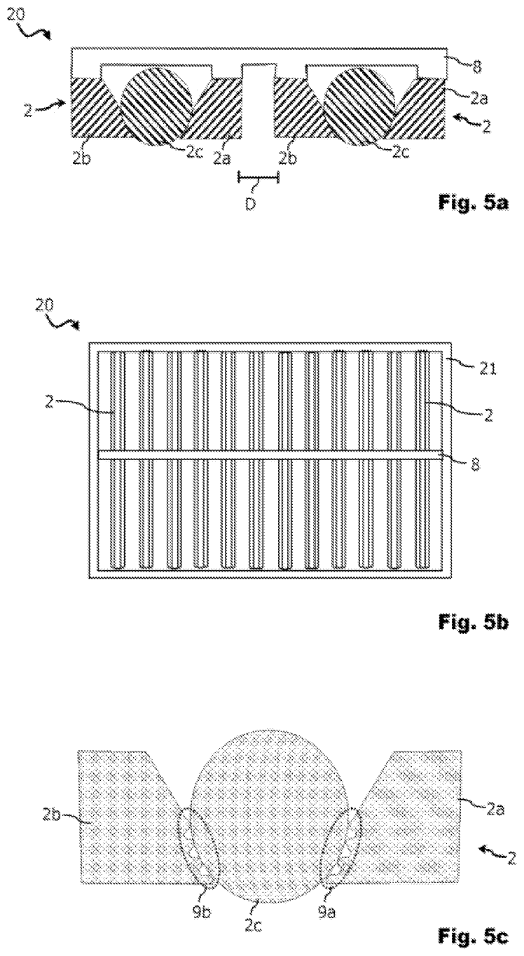

FIG. 5a shows a cross-sectional view of two food support elements 2 of an sloping grillage 20, which can be made of cast iron, for example. In this case, each of the food support elements 2 has three carrier rods 2a, 2b, 2c, so that the distance between carrier rods 2a and 2c and between carrier rods 2b and 2c is less than 1 mm—preferably abutting, as shown in FIG. 5a—and the carrier rods are arranged next to each other. The middle carrier rod 2c is a round rod and protrudes higher from the food support surface than the two lateral carrier rods 2a and 2b with a respective trapezoidal cross-sectional profile. The carrier rod 2c can be replaced by a trapezoidal rod.

In FIG. 5c it is shown that the two lateral carrier rods 2a and 2b have recesses, which are generally designated by reference numerals 9a and 9b in FIG. 5c, along the rod extension direction at the contact surfaces with the middle carrier rod 2c. These recesses can have a depth between 10 μm and 2 mm, for example, and have a groove-shaped course. The effective surface area of the carrier rods 2a, 2b is increased by the recesses and thus the fat transport capacity is increased.

FIG. 5b illustrates a top view of the sloping grillage 20 with the food support elements 2 of FIG. 5a or 5c. The grillage frame 21 can be rectangular in this case and the respective food support elements 2 or carrier rods 2a, 2b, 2c can be removably inserted on the longitudinal sides of the grillage frame. Or the grillage frame 21 with cross bars 8 and carrier rods 2a and 2b are cast as a whole body. The cross bar 8 stabilizes the brittle carrier rods 2a and 2b. The cast or drawn round carrier rod 2c is loosely placed between the carrier rods 2a and 2b. The number of cross bars 8 is exemplarily shown in FIG. 5b with one cross bar running centrally through the grillage frame, but of course the number of cross bars 8 can also be lower or higher depending on the size of the sloping grillage 20 and the desired bending stability of the food support elements 2.

FIG. 15 shows a sloping grillage with curved support bars that run 2-dimensionally in one plane. FIG. 5a shows a cross-sectional view of an example according to FIG. 15. FIG. 5c shows a cross-sectional view of another example according to FIG. 15, where the two lateral support bars 2a and 2b have recesses along the bar extension direction at the contact surfaces with the central support bar 2c. The grillage frame 21 including crossbar 8 and support bars 2a and 2b can be cast as a whole body. Support bars 2a and 2b with a trapezoidal cross-sectional profile run 2-dimensionally curved. Round or trapezoidal support bars 2c made of cast iron or steel can be loosely inserted between 2a and 2b. In the example, the inclination angle of the support bars 2a, 2b and 2c against the horizontal is not constant, but oscillates around a mean value. The support bars 2a, 2b and 2c run at inclination angles of 1°-30° against the horizontal during grill operation of the sloping grillage.

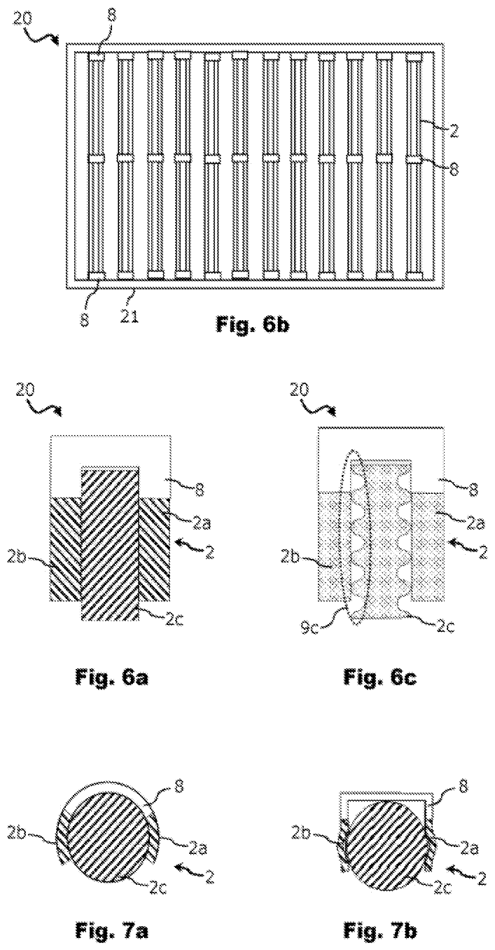

FIGS. 6a and 6c again show cross-sectional views of a grill food support element 2 of an sloping grillage 20, which can be made, for example, of cast iron, rolled or extruded sheets or profiles. A grill food support element 2 can have three rectangular strips as support bars. The central support bar 2c is higher than the two lateral support bars 2a and 2b. The three support bars are held together by crossbars 8 so that the small distance between the support bars remains guaranteed even with thin material thickness. Alternatively, the support bars can also be connected by pins or bolts. All support bars can then be removably inserted into the grillage frame 21. As shown in FIG. 5c, the central support bar 2c can have grooves with a depth of between 10 μm and 2 mm on the side surfaces closest to the support bars 2a and 2b. As a result, more liquid or fat can be transported away due to a stronger capillary effect. Alternatively, the surface roughness can be increased or depression patterns can be introduced into the side surface of the support bar 2c. The grooves, patterns, depressions or large roughness can be realized e.g. by casting, rolling, pressing, extruding, drawing, sheet forming, grinding or sandblasting etc. The support bars 2a and 2b can be formed for example by forming a sheet strip or casting. Alternatively, 2a and 2b can also have grooves or patterns. The support bar 2c can be smooth or have grooves or patterns.

FIG. 6b illustrates a top view of the sloping grillage 20 with the grill food support elements 2 of FIG. 6a or 6c. In this case, the grillage frame 21 can be rectangular and the respective grill food support elements 2 or support bars 2a, 2b, 2c can be removably inserted on the longitudinal sides of the grillage frame 21. The crossbar 8 in FIG. 6b connects 2a and 2b in a support element. The support bars 2a, 2b and the crossbar 8 in a support element can be made from one piece of sheet metal. Alternatively, it may also be possible to connect the crossbar 8 as a U-shaped metal piece to the support bars 2a and 2b by welding. The support bar 2c is inserted between the support bars 2a and 2b. The number of crossbars 8 is shown in FIG. 6b as an example with three rows. The crossbars 8 of one row can also form a whole continuous crossbar 8. Of course, the number of crossbars/cross-connection rows can also deviate from three depending on the size of the sloping grillage 20 and the desired bending stability of the grill food support elements 2.

FIG. 6d shows a top view of a sloping grillage 20 with three rectangular strips. Instead of a frame, the sloping grillage 20 is held together here by crossbars 8, which can be bolts, for example, and spacers 158. Each support bar 2a, 2b and 2c has two holes through which the crossbars 8 are inserted. The diameter of the bolts can be smaller than the hole diameters in the support bars 2a, 2b and 2c so that the support bars 2a, 2b and 2c can expand freely at uneven heat. Such a sloping grillage can be inserted into a grill cart with adjustable grate height, where one crossbar 8 can be inserted into a notch at one height of the grill cart and the other crossbar 8 into another notch at another height. The inclination of the sloping grillage is defined by the height difference between the two notches.

FIGS. 7a and 7b again show cross-sectional views of a grill food support element 2 of a sloping grillage 20. A support element consists of a support bar 2c in round bar and two lateral support bars 2a and 2b in curved polygonal strip profile. The three support bars 2a, 2b and 2c are held together by a plurality of cross-connections or crossbars 8. The polygonal strip profiles of the support bars 2a and 2b can be tubular or U-shaped, for example. The optional waves at the contact surfaces between the central support bar 2c and the lateral support bars 2a, 2b can advantageously enhance the capillary effect, whereby more liquid or fat can be transported away. The support bars 2a, 2b can be made from a tube, for example. For further stabilization of the grill food support elements 2, crossbars 8 or cross-connections can be drawn in both above and below.

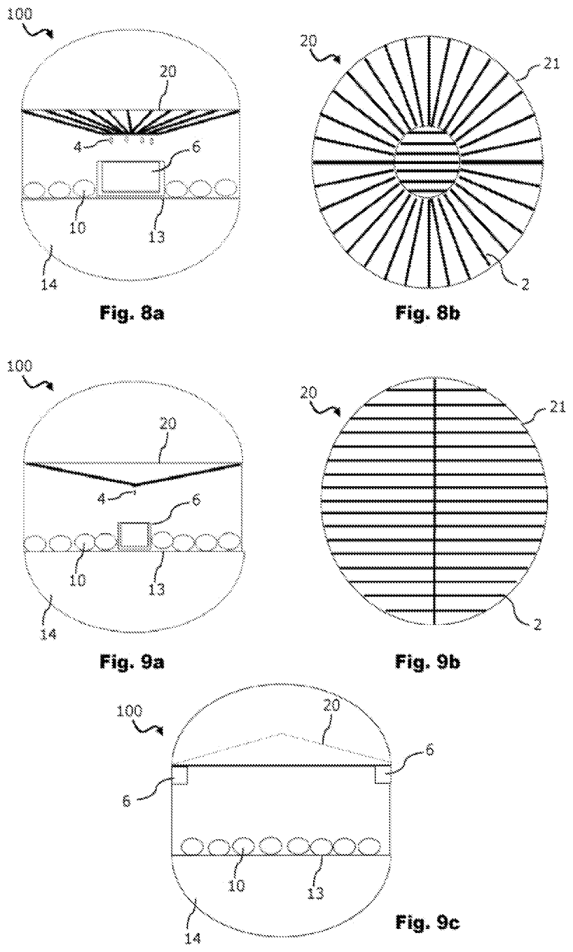

FIG. 8a shows a cross-section of a side view of a kettle grill as a dry cooking device 100 with a cooking chamber 14. The cooking chamber 14 can be closed with a lid, but can also be open to the environment if the lid remains open or if a grill is built without a lid. The kettle grill has a funnel-shaped sloping grillage 20 and a central bowl as a fat collecting container 6 into which fat 4 drips from the lowest point of the funnel-shaped sloping grillage 20. The sloping grillage 20 of FIG. 8a has a circular grillage frame 21, so that the grill food support elements 2 spaced apart from each other run radially from the circumference of the grillage frame 21 to a center of the grillage frame 21 along their longitudinal extension, as illustrated in FIG. 8b. In the center, the grillage frame 21 has an inner ring on whose circumference the grill food support elements 2 end. Inside the inner ring, a flat grill food support area can be formed, for example with a conventional grillage made of simple parallel round bars. In this flat grill food support area in the center of the sloping grillage 20, food can be grilled under indirect heat radiation. Glowing charcoal 10 can lie on a floor 13 in the cooking chamber 14 as an underside heat source, for example. The sloping grillage 20 can be built in several parts to allow cleaning with a dishwasher and/or to add charcoal during grilling.

FIG. 9a shows a cross-section of a side view of a kettle grill as a dry cooking device 100 with a cooking chamber 14. The cooking chamber 14 can be closed with a lid, but can also be open to the environment if the lid remains open or if a grill is built without a lid. The kettle grill has a V-shaped sloping grillage 20 in the cooking chamber and a central, elongated fat collecting container 6 below the lowest point of the sloping grillage 20 into which dripping fat 4 from the food can drip. As can be seen in FIG. 9b, the grill food support elements 2 spaced apart from each other run parallel to each other along their longitudinal extension within the (here circular) grillage frame 21. The grill food support elements 2 are inclined relative to the horizontal and from both edges of the grillage frame 21 towards the center. The central fat collecting container 6, which divides the entire charcoal grate circle, can be relatively narrow so that essentially all food that rests on the sloping grillage 20 can be grilled under direct heat radiation from the glowing charcoal 10 lying on a floor 13 in the cooking chamber 14. The sloping grillage 20 can be built in several parts to allow cleaning with a dishwasher and/or to add charcoal during grilling.

As illustrated by way of example in FIG. 9c, the position of the V-shaped sloping grillage 20 in a cooking chamber 14 of a kettle grill as a dry cooking device 100 can also be inverted: Then the grill food support elements 2 spaced apart from each other run parallel to each other along their longitudinal extension within the (here circular) grillage frame 21, but relative to the horizontal and from the center of the grillage frame 21 towards both edges of the grillage frame 21 sloping downwards. As a result, two lateral, for example arcuate fat collecting containers 6 can be provided at the edge of the cooking chamber 14. This is advantageous because the dripped fat cools down faster at the edge of the cooking chamber 14 and the entire floor area of floor 13 can be covered with glowing charcoal 10 to achieve more even heat distribution over the entire grill food support area. The sloping grillage 20 can be built in several parts to allow cleaning with a dishwasher and/or to add charcoal during grilling.

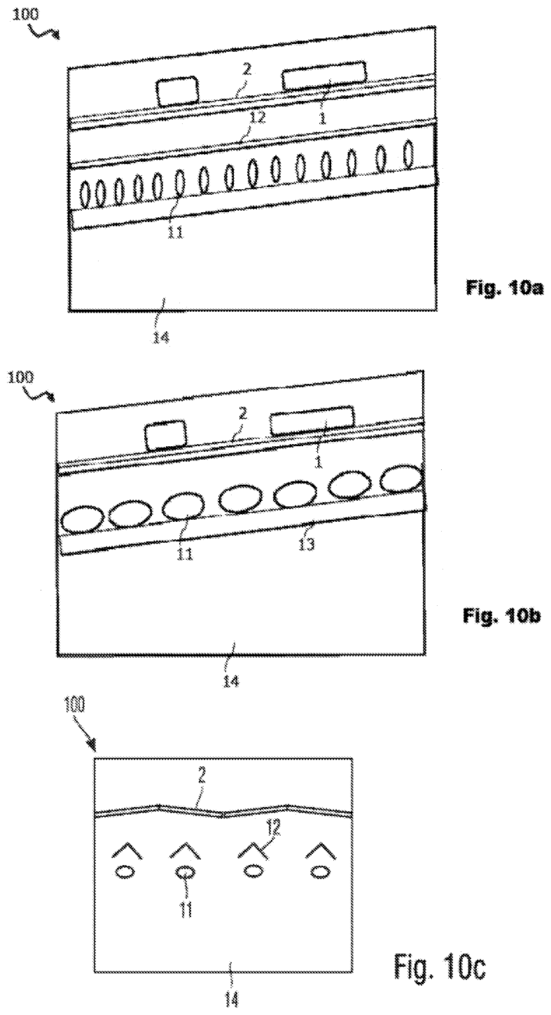

FIGS. 10a, 10b and 10c each show cross-sections of the side view of different dry cooking devices. FIG. 10a shows a gas grill as a dry cooking device 100 with a sloping grillage 20, which can be designed, for example, as in FIG. 5b or 6b. The gas grill has a cooking chamber with gas burners 11 and associated flame covers 12, which each run parallel to the inclined grill food support elements 2. This design achieves the most even heat distribution possible over the entire grill food support area of the sloping grillage 20. FIG. 10b shows in an analogous manner a charcoal grill as a dry cooking device 100 with an sloping grillage 20 and an inclined charcoal grate with a floor 13 on which charcoal 10 rests. Finally, FIG. 10c shows a gas grill as a dry cooking device 100 with roof-shaped sloping grillages 20. Two roof-shaped, i.e. inverted V-shaped, sloping grillages 20 with inclined grill food support elements 2 are located above gas burners 11 and flame covers 12. The grillage frames of the two sloping grillages 20 can meet at a point where there are gaps between adjacent flame covers 12. This can halve the height difference between the different longitudinal ends of the inclined grill food support elements 2 while maintaining the same grill width, making heat distribution even more even. Dripping fat drips through the gap between two flame covers 12 and can be collected on an intermediate sheet located below the gas burners 11 and directed to a fat collecting container.

In the preceding detailed description, various features have been summarized in one or more examples to improve the coherence of the presentation. However, it should be clear that the above description is merely illustrative and not limiting in nature. It serves to cover all alternatives, modifications and equivalents of the various features and embodiments. Many other examples will be immediately and directly clear to those skilled in the art based on their technical knowledge in light of the above description.

The embodiments have been selected and described to best illustrate the principles underlying the invention and its practical applications. This enables those skilled in the art to optimally modify and use the invention and its various embodiments with respect to the intended purpose. In the claims and description, the terms “including” and “having” are used as neutral language terms for the corresponding terms “comprising”. Furthermore, the use of the terms “one”, “an” and “a” does not fundamentally exclude a plurality of such described features and components.

1. A sloping grillage, comprising:
a number of grill food support elements spaced apart with a distance D from each other,
wherein at least 70% of the grill food support elements are each composed of at least two support bars that do not have fat channels, of which at least one support bar is spaced less than 1 mm from at least one of the other support bars, and
wherein the at least two support bars of a grill food support element run at inclination angles between 1° and 30° relative to the horizontal during grill operation of the sloping grillage.

2. The sloping grillage of claim 1, wherein at least one of the support bars of the grill food support elements is a round bar and at least one of the support bars of the grill food support elements has a non-round profile.

3. The sloping grillage of claim 1, wherein all of the support bars of the grill food support elements have a non-round profile.

4. The sloping grillage of claim 1, wherein all of the support bars of the grill food support elements have a round bar.

5. The sloping grillage of claim 1, wherein at least 70% of the grill food support elements are each composed of at least three support bars, of which at least one support bar is spaced less than 1 mm from at least two of the other support bars, and wherein at least three support bars of a grill food support element run at inclination angles between 1° and 30° relative to the horizontal during grill operation of the sloping grillage.

6. The sloping grillage of claim 1, wherein at least one of the support bars of the grill food support elements is arranged offset by a depth distance perpendicular to the grill food support plane formed by the grill food support elements.

7. The sloping grillage of claim 1, wherein at least two support bars in a grill food support element are connected in multiple places in the longitudinal direction.

8. The sloping grillage of claim 1, wherein at least one of the support bars of the grill food support elements has depressions on at least one side surface closest to one of the other support bars.

9. The sloping grillage of claim 8, wherein the depressions have a depth between 10 μm and 2 mm.

10. The sloping grillage of claim 1, wherein at least one of the support bars of the grill food support elements has different cross-sectional dimensions than the other support bars.

11. The sloping grillage of claim 1, wherein the grill food support elements spaced apart from each other run parallel to each other along their longitudinal extension.

12. The sloping grillage of claim 1, wherein the sloping grillage is circular and the grill food support elements spaced apart from each other run radially from the circumference of the sloping grillage to a center along their longitudinal extension.

13. The sloping grillage of claim 1, wherein the support bars of the grill food support elements spaced apart from each other along their longitudinal extension are connected to the grillage frame or the crossbars in a displaceable manner relative to a grillage frame or the crossbars.

14. A dry cooking device, comprising:
a cooking chamber; and
at least one sloping grillage arranged in the cooking chamber, the sloping grillage comprising:
a number of grill food support elements spaced apart with a distance from each other,
wherein at least 70% of the grill food support elements are each composed of at least two support bars that do not have fat channels, of which at least one support bar is spaced less than 1 mm from at least one of the other support bars, and
wherein the at least two support bars of a grill food support element run at inclination angles between 1° and 30° relative to the horizontal during grill operation of the sloping grillage.

15. The dry cooking device of claim 14, further comprising:
at least one fat collecting container, which is arranged within the cooking chamber below the lowest point relative to the horizontal of the sloping grillage.

16. The dry cooking device of claim 14, wherein the cooking chamber has a circular cross-sectional profile and the sloping grillage is designed to be circular and to have the grill food support elements spaced apart from each other run radially from the circumference of the sloping grillage to a center along their longitudinal extension.

17. The dry cooking device of claim 14, further comprising a heat source the heat-generating elements of which are arranged substantially at a constant distance from the grill food support elements of the sloping grillage in the cooking chamber.

18. The sloping grillage of claim 3, wherein all of the support bars of the grill food support elements have a rectangular or trapezoidal strip profile.

19. The sloping grillage of claim 8, wherein the depressions of the at least one of the support bars of the grill food support elements run along the bar extension direction.

20. The dry cooking device of claim 14, wherein the dry cooking device is an oven, a kettle grill, a round grill, a column grill, a funnel grill, a swing grill, a garden grill, a grill cart, a grill station or a grill fireplace.
